(19) United States
(12) Patent Application Publication
(10) Pub. No.: US 2007/0095756 A1
(43) Pub. Date: May 3, 2007

(54) System and method for removal of contaminants from feed solution

(75) Inventors: Canan Uslu Hardwicke, Simpsonville, SC (US); Aaron John Avagliano, Houston, TX (US); Gregory Robert Chambers, Clifton Park, NY (US); Stephen Francis Rutkowski, Duanesburg, NY (US); Edward Joseph Hall, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/263,167

(22) Filed: Oct. 31, 2005

(51) Int. Cl. B01D 61/02

(52) U.S. Cl. 210/652; 210/639; 210/321.6; 210/456; 210/506

(57) ABSTRACT

A system is provided for contaminant removal. The system includes an inlet for transmitting a contaminated solution and a reverse osmosis membrane having at least one flow modifier. The reverse osmosis membrane is configured to separate condensate and permeate from the contaminated solution. The system also includes a porous central tube for carrying the permeate and an outlet for the condensate. A method is also provided for removing contaminants from a solution.

### BACKGROUND

The invention relates to a spiral-wound type membrane separation device. More specifically, the invention relates to a spiral-wound membrane separation device for use in reverse osmosis applications.

Spiral-wound membrane elements for reverse osmosis applications have long been regarded as efficient mechanisms for separating components of fluid mixtures. Typically, a pressurized fluid mixture is brought into contact with a membrane surface and a pressure differential is applied to the membrane to cause the fluid mixture to be transmitted through the membrane. One or more components of the fluid mixture pass through the membrane owing to a difference in chemical potential of the component in the fluid mixture before the fluid mixture enters the membrane and after it comes out through the membrane. Owing to varying mass transport rates of various components of the fluid mixture before the mixture enters the membrane and after it comes out through the membrane, separation of the components is achieved.

Known spiral-wound membrane systems use feed spacers with constant channel geometry in an open fabric structure. The constant channel geometry provides convective flow to the fluid mixture, which results in a pressure drop that varies with the cross-flow velocity of the feed solution. Conversion efficiency of known spiral-wound membrane systems as described by the ratio of the flow rate with permeate pressure loss to the flow rate without permeate pressure loss may be increased if the boundary layer formed by the surface liquid is broken.

### BRIEF DESCRIPTION OF THE DRAWINGS

FIG. 1 is a schematic view of a contaminant removal system constructed in accordance with an exemplary embodiment of the invention.

FIG. 2 is a perspective view of fluid flow conditions within the contaminant removal system of FIG. 1.

FIG. 3 illustrates an exemplary method for removing contaminants from feed solution in accordance with an embodiment of the invention.

### SUMMARY

In accordance with one embodiment of the invention, a contaminant removal system is provided. The system includes an inlet for transmitting a contaminated solution and a reverse osmosis membrane that has at least one flow modifier. The reverse osmosis membrane is configured to separate condensate and permeate from the contaminated solution. The system also includes a porous central tube for carrying the permeate and an outlet for the condensate.

In accordance with another embodiment of the invention, a method is provided for removing contaminants from a solution. The method includes providing the solution to a reverse osmosis system. The reverse osmosis system includes an inlet for the solution and a reverse osmosis membrane that has at least one flow modifier for separating permeate and condensate from the solution. The method also includes transmitting the permeate through a first conduit and the condensate through a second conduit.

In accordance with another embodiment of the invention, a method for making a contaminant removal system is provided. The method includes providing an inlet for transmitting a contaminated solution, disposing a reverse osmosis membrane in fluid communication with the inlet, configuring the reverse osmosis membrane by disposing at least one flow modifier on the reverse osmosis membrane, separating condensate and permeate from the contaminated solution, disposing a porous central tube for carrying the permeate, and providing an outlet for the condensate.

### DETAILED DESCRIPTION OF EXEMPLARY EMBODIMENTS

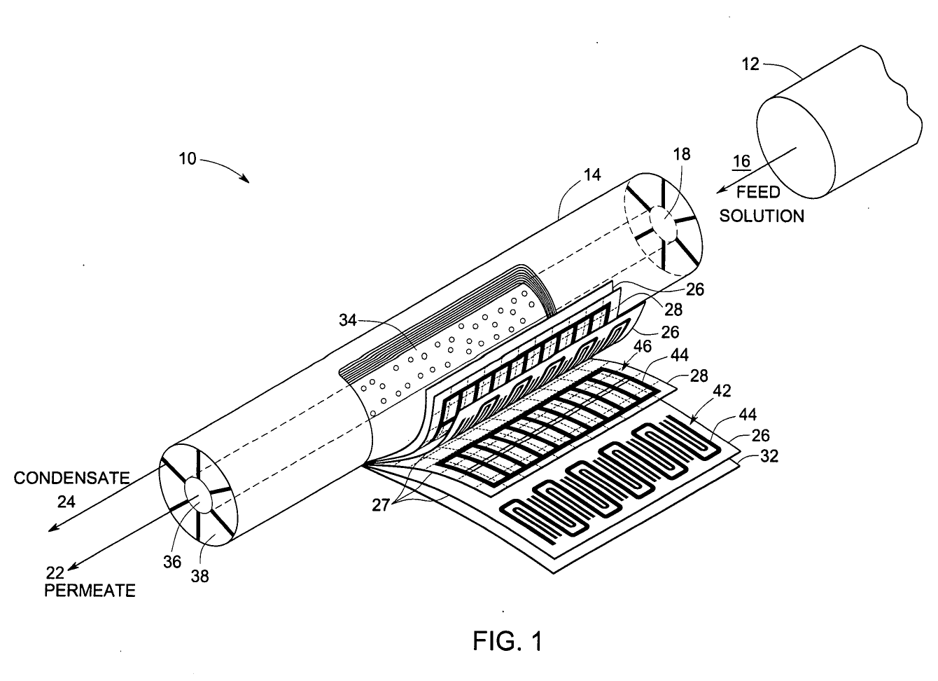

FIG. 1 schematically illustrates a contaminant removal system 10 constructed in accordance with an exemplary embodiment of the invention. The contaminant removal system 10 includes a conduit 12 that carries a feed solution 16 from a source (not shown) to a reverse osmosis membrane system 14. The reverse osmosis membrane system 14 serves to separate the feed solution 16 into a stream of permeate 22 and a stream of condensate 24. Feed solution 16, such as a contaminated feed solution, is supplied from the conduit 12 into the reverse osmosis membrane system 14 through an inlet 18. The reverse osmosis membrane system 14 includes at least one reverse osmosis membrane 26 and at least one feed spacer 28. The reverse osmosis membrane system 14 is contained in an outer wrap 32. After entering the reverse osmosis membrane system 14, the incoming feed solution 16 flows axially through the reverse osmosis membrane system. A permeating portion of the feed solution 16, the permeate 22, is spirally separated, collected in a central porous tube 34 and finally taken out through an outlet 36. A non-permeating portion of the feed solution 16, the condensate 24, is collected out through an outlet 38.

The term “feed solution”, such as the feed solution 16, is used to describe a liquid containing at least one other component, usually a dissolved solid or liquid; however, more than one other component may be present. In some applications, the feed solution may carry suspended solids of minute size. As used throughout, the term “permeate” is used to identify the component of the feed solution being separated from the “condensate”, which is a term to identify the remainder of the feed solution.

The reverse osmosis membrane system 14 of FIG. 1 is shown with a portion of the membrane system in an unwound state to illustrate the flow direction of the permeate 22 and the condensate 24. Flat sheet membranes 26, and spacers 28, which may be formed of porous fabric or plastic sheets or webs, are attached (normally with adhesive) to and wound about a central porous tube 34. The spacers 28 between membranes 26 serve to transport the feed solution 16, create turbulence and provide structural support against collapse to a number of flow channels or passageways through the membrane 26 that carry the flow of the feed solution 16. The illustrated reverse osmosis system 14 includes a multilayer wrapping about a central tube 34 which serves as a permeate collection conduit. The sidewall of the tube 34 is made porous so that permeating liquid from the reverse osmosis membrane system 14 can enter the tube 34.

The tube 34 and an arrangement of the various sheet material 26 and 28 create a number of composite leaves 27, within each of which leaves 27 one length of the feed spacer material 28 is sandwiched between two facing sheets of membrane 26. To ensure good liquid communication through the perforations into the center of the tube 34, one of the sheets of permeate material 32, which may be made of Dacron fabric or of rigidized knitted Tricot or the like, may be attached to the exterior surface of the tube 34 as an outer wrap 32. The lateral edges of the feed spacer 28 may be adhesively attached to the membrane sheets 26 by suitable bands of strips of adhesive, which also serves to seal the lateral edges so as to prevent any entry of feed solution 16 at any location other than at the inlet 18, while providing a bond between membranes 26 and feed spacers 28 to create the leaves 27. Once the spiral winding of the reverse osmosis membrane system 14 is complete, it assumes the substantially cylindrical configuration depicted in FIG. 1, and it is then appropriately inserted into a seamless, highly porous, substantially rigid, tubular sleeve. Although the central tube 34 may extend out one or both ends of the reverse osmosis membrane system 14, in the illustrated embodiment it is shown as being flush with the ends of the windings.

A variety of different reverse osmosis membranes 26 may be used in the reverse osmosis membrane system 14. In one instance, the membrane 26 may be a thin-film composite membrane. More specifically, the membrane 26 may be a spiral wound thin-film composite membrane, such as, for example, an S series thin-film composite membrane. The membrane may be able to withstand the desired process parameters associated with an industrial reverse osmosis process. Both anisotropic (asymmetric) membranes having a single or double barrier layer (skin) and isotropic membranes may be made in flat sheet form for reverse osmosis applications. The membranes 26 may be made of a single polymer or of a copolymer. Further, the membranes 26 may be laminated or formed of a composite structure wherein a charged or uncharged thin barrier coating or film is formed over a thicker substrate film, the latter being either porous or non-porous (diffusional). The polymers suitable for such membranes may range from the highly stable hydrophobic materials such as polyvinylidene fluoride, polysulfones, modacrylic copolymers polychloroethers and the like normally used for ultrafiltration, microfiltration and gas filtration applications and as substrates for reverse osmosis composites, to the hydrophilic polymers such as cellulose acetate and various polyamines.

In one embodiment of the invention the membrane 26 may be of the asymmetric type, such as the cellulose acetate membranes wherein a thin, active, dense layer is formed at one surface of cast polymeric material by selective evaporation or the like, whereas the remainder of the membrane 26 throughout and extending to the other surface is of a much more porous composition which tends to integrally support the dense active surface layer which exhibits the semipermeable characteristics.

Alternatively, membranes 26 may be formed such that a dense, active layer is formed of a chemically different material than a non-active supporting layer. Such membranes 26 may be made by any suitable method. However, an interfacial condensation reaction may be carried out whereby a thin film is formed by reactants, which create a thin, dense, polymeric surface, such as a polyamide having the desired semipermeable characteristics. The porous, less dense, supporting layer adjacent to which the interfacial condensation reaction takes place may be of any suitable polymeric material, such as a polysulfone, having the desired pore size to adequately support the ultra-thin, interfacial layer without creating undesirably high pressure drops across it. In yet another instance, suitable reverse osmosis membranes 26 may be made by casting suitably porous membranes from polysulfone or by using other known polymeric materials.

The feed spacers 28 may be positioned on the feed-condensate side of the membrane 26 (i.e., the side with the active barrier membrane surface of “skin”) and a knitted fabric sheet spacer for permeate transport on the opposite, i.e., permeate side. Using known industrial adhesives and cements, or other sealing means such as heat sealing, the spacers 28 or leaves 27 of membranes 26 and spacers 28 are bonded to form flow paths. In reverse osmosis applications the reverse osmosis membrane system 14 may be inserted in a pressure vessel tube for high pressure filtration. In another instance, depending upon the desired flow configuration, a number of repeating membrane envelopes and spacers may be wound about a single porous core tube.

In the reverse osmosis membrane system 14, the feed spacer material 28 is selected to be a material, which provides a number of flow channels or passageways for the flow of the feed solution 16 through the membrane 26. The flow channels or passageways extend axially from the inlet 18 to the outlet end 36 of the reverse osmosis membrane system 14 and are sufficiently flexible to allow spiral winding of the feed spacer 28 about the central porous tube 34. As elaborated earlier, the function of the feed spacer 28 is to space the facing active surfaces of the panels of permeable membrane 26 apart from each other so that the feed solution 16 being pumped through the reverse osmosis membrane system 14 may flow in contact with both active surfaces through which permeation occurs. Any suitable, relatively porous material may be used that will not cause undesirably high pressure drops over the length of the axial passage therethrough. Synthetic fiber materials may be used, such as those made from thermoplastic polymers, including polyethylene and polypropylene. In another embodiment of the invention, woven screening material may be used for feed spacers 28 in such spiral-wound reverse osmosis membrane system 14. In another embodiment of the invention, polypropylene netting or screening material may be used to make the feed spacer 28 in which parallel filaments are oriented at predetermined angles to the axial flow path.

As illustrated in FIG. 1, the reverse osmosis membrane 26 is structurally modified by forming a number of flow modifiers 42 on the surface of the reverse osmosis membrane 26. The flow modifiers 42 may be formed by depositing surface modifying agents 44 on the surface of the membrane 26. The flow modifiers 42 may be formed in a variety of ways. In one embodiment of the invention, the flow modifiers 42 may include sharp faces. In another embodiment of the invention, the flow modifiers 42 may include a flexible structure. In another embodiment of the invention, the flow modifiers 42 may be formed by embedding silicon on the surface of the membrane 26. In a further embodiment of the invention, the reverse osmosis membrane 26 may be modified by forming the flow modifiers 42 in accordance with the geometry of the feed spacer 28 directly on the surface of the membrane 26. In yet another embodiment of the invention, the feed spacers 28 may include a flexible structure 46 formed by depositing surface modifying agents 44. In some embodiments of the invention, the flow modifiers 42 on the surface of the reverse osmosis membranes 26 as well as the flexible structure 46 on the feed spacers 28 may be formed by depositing surface modifying agents 44. Forming the flow modifiers 42 on the reverse osmosis membranes 26 or the flexible structures 46 on the feed spacers 28 may lead to a reduction of boundary layer development on the flow path of the feed solution 16.

There may be various types of materials used as surface modifying agents 44. In one embodiment of the invention, the surface modifying agents 44 may include polymer-based low viscosity materials in liquid or semi-liquid form. In another embodiment of the invention the surface modifying agents 44 may be ceramic materials in liquid or semi-liquid form. In yet another embodiment of the invention the surface modifying agents 44 may be metal-based materials in liquid or semi-liquid form. All these types of surface modifying agents 44 will be described in more detail below.

There are various ways by which the surface modifying agents 44 may be deposited on the surface of reverse osmosis membrane 26. In one embodiment of the invention, the flow modifiers 42 and/or the flexible structures 46 may be formed by coating a profile of surface modifying agent 44 onto the reverse osmosis membrane 26 and/or the feed spacer 28. The surface modifying agent 44, preferably a polymer or metal-based or ceramic material, should be carefully formulated and applied to avoid substantial penetration of the surface modifying agent 44 into the knit permeate fabric. Substantial penetration may reduce transport of the feed solution 16 through the fabric of the membrane 26. In one embodiment of the invention, preventing substantial penetration by the surface modifying agents 44 may be accomplished by applying a uniform non-porous polyurethane coating to the surface of the membrane 26. The polymer coating may be of such composition and thickness that it will adhere uniformly to the surface of the membrane 26 even when the membrane 26 is rolled into a tight cylinder in a reverse osmosis membrane system 14.

In some embodiments of the invention, the surface modifying agents 44 may be deposited on the membrane 26 and/or the feed spacer 28 to form profiled ceramic coating such that the surface modifying agents 44 do not destructively alter the surface structure of the membrane 26 and/or the feed spacer 28. Accordingly, a profiled coating of the surface modifying agents 44 may be formed on the membrane 26 and/or the feed spacer 28 in a number of methods that may include thermal spraying, e.g., plasma spraying, a ceramic or metal-based coating onto the membrane 26 and/or the feed spacer 28. In another embodiment of the invention, the method of producing a profiled coating of surface modifying agents 44 on the membrane 26 and/or the feed spacer 28 may include thermal spraying, e.g., plasma spraying, a ceramic coating or a metal-based composition onto the membrane 26 and/or the feed spacer 28 using a narrow foot-print plasma gun which may be manipulated by a robot to create the desirable pattern. The surface modifying agents 44 used may be a metallic bond coat such as MCrAlY, where M may be Ni, NiCo, Co, or Fe.

In another embodiment of the invention, the profiled coating may be in the form of stripes of porous ceramic coatings of yttria stabilized zirconia (YSZ) as in the case of thermal barrier coatings, or barium strontium aluminosilicate (BSAS) as in the case of environmental barrier coatings for Si-based ceramic matrix composite (CMC) components. The pattern may be straight or contoured/curved diamond, chevron, or irregular in shape. The stripes may form the flow modifiers described above on the flow path of the feed solution 16. Since ceramic, for the purpose of reducing clearance, cannot be a continuous layer, a profiled coating using ceramic is made into intermittent ridges. The ridges serve to obstruct the flow of feed solution 16 over the reverse osmosis membranes 26 and/or the feed spacer 28. One embodiment includes a ridge pattern that achieves reduced pressure losses in the flow of the feed solution 16 and increased low angle erosion resistance of the ridge walls.

In another embodiment of the invention, polymer based surface modifying agents 44 may be used to form the flow modifiers 42 on the reverse osmosis membrane 26 and/or the flexible structures 46 on the feed spacer 28. The method of forming the flow modifiers 42 and/or the flexible structures 46 may include providing a polymerizable composite including a polymer binder and an uncured monomer, depositing the polymerizable composite on the membrane to form a layer, patterning the layer to define an exposed area and an unexposed area of the layer, curing the exposed area of layer, and volatilizing the uncured monomer to form the membrane. The curing may be done in any suitable way, such as, for example, through irradiation. The polymerizable composite may be deposited by any suitable deposition methods, such as, for example, direct writing, plasma spraying, thermal spraying, non-thermal spraying, inkjet and the like.

In another embodiment of the invention, a method of forming the flow modifiers 42 and/or flexible structures 46 may include forming a topographic profile on the membrane 26 and/or feed spacers 28. The method may include providing a polymerizable composite, depositing the polymerizable composite on a surface of a membrane to form a layer, patterning the layer to define an exposed area and an unexposed area of the layer, curing a portion of the layer to form a polymerized portion and an uncured portion, and removing the uncured monomer from at least one of the polymerized portion and the uncured portion. The removal of the uncured monomer forms a topographic profile. The polymerizable composite includes at least one polymer binder and at least one uncured monomer. The polymer binder may include at least one of a cyclic olefin copolymer, an acrylate polymer, a polyester, a polyimide, a polycarbonate, a polysulfone, a polyphenylene oxide, a polyether ketone, a polyvinyl fluoride, and combinations thereof. The uncured monomer includes at least one of an acrylic monomer, a cyanate monomer, a vinyl monomer, an epoxide-containing monomer, and combinations thereof.

The patterning of polymerizable composite on the reverse osmosis membrane 26 and/or the feed spacer 28 may be carried out so as to define an area that may be exposed to curing radiation. Ultraviolet (UV) radiation may be used as the curing radiation. During the curing step, the monomer polymerizes in the areas exposed to the curing radiation. By suitably varying the process conditions and the composition of the polymerizable composite, it is possible to obtain a variety of surface topographies, thereby leading to a variety of flow modifiers 42 on the membrane 26 and/or a variety of flexible structures 46 on the feed spacer 28. In one embodiment of the invention, the surface topography may include at least one step. The step may be either an upward or a downward step. Moreover, the step can have an angled, concave, or convex profile.

The polymerizable composite used as surface modifying agents 44 may include a polymer binder and an uncured monomer. The polymer binder may include any polymer that is thermally stable during the monomer evaporation step. The polymer binder should also be compatible with the monomer chosen. In one embodiment of the invention, the polymer binder may include at least one of an acrylate polymer, a polyetherimide, a polyimide, a siloxane-containing polyetherimide, a polyester, a polycarbonate, a siloxane-containing polycarbonate, a polysulfone, a siloxane-containing polysulfone, a polyphenylene oxide, a polyether ketone, a polyvinyl fluoride, and combinations thereof. In a particular embodiment, the acrylate polymer includes at least one of poly(methyl methacrylate), poly(tetrafluoropropyl methacrylate), poly(2,2,2-triflouroethyl methacrylate), copolymers including structural units derived from acrylate polymers, and combinations thereof. In another embodiment, the polyimide includes the building blocks, 2,2′-bis[4-(3,4-dicarboxyphenoxy) phenyl] propane dianhydride, 1,3-phenylenediamine, benzophenonetetracarboxylic acid dianhydride and 5(6)-amino-1-(4′-aminophenyl)-1,3-trimethylindane.

The monomer may include any monomer that is compatible with the polymer binder, may be polymerized by exposure to radiation. The monomer may be mono-functional; that is, it forms a thermoplastic polymer during irradiation. Alternatively, the monomer may be poly-functional; that is, it forms a thermosetting polymer matrix when irradiated. The monomers may react with both themselves and the polymer binder during irradiation. The uncured monomer includes at least one of an acrylic monomer, a cyanate monomer, a vinyl monomer, an epoxide-containing monomer, and combinations thereof. Non-limiting examples of monomers include acrylic monomers, such as methyl methacrylate, 2,2,2-trifluoroethyl methacrylate, tetrafluoropropyl methacrylate, benzyl methacrylate, and glycol-based and bisphenol-based diacrylates and dimethacrylates; epoxy resins, such as, but not limited to: aliphatic epoxies; cycloaliphatic epoxies, such as CY-179; bisphenol-based epoxies, such as bisphenol A diglycidyl ether and bisphenol F diglycidyl ether; hydrogenated bisphenol-based and novolak-based epoxies; cyanate esters; styrene; allyl diglycol carbonate; and others.

In addition to the at least one polymer binder and the monomer, the polymerizable composite material may further include a photo-catalyst or a photo-initiator, a co-catalyst, an anti-oxidant, additives such as, but not limited to, chain transfer agents, photo-stabilizers, volume expanders, free radical scavengers, contrast enhancers, nitrones, and UV absorbers, and a solvent, the latter being present to facilitate spin coating the polymerizable composite material onto a membrane.

When the radiation curable compounds described above are cured by ultraviolet radiation, it is possible to shorten the curing time by adding a photosensitizer, such as, but not limited to, benzoin, benzoin methyl ether, benzoin ethyl ether, benzoin isopropyl ether, benzil (dibenzoyl), diphenyl disulfide, tetramethyl thiuram monosulfide, diacetyl, azobisisobutyronitrile, 2-methyl-anthraquinone, 2-ethyl-anthraquinone or 2-tert-butylanthraquinone, to the monomer, oligomer, or polymer component or its solution.

Although the curing radiation is referred to herein as ultraviolet radiation, it is understood that other radiation sources may be used to cure the polymerizable composite as well. In addition to radiation, other forms of curing, such as, but not limited to, a laser may be used.

In a further embodiment of the invention, the profiled coatings applied on the reverse osmosis membrane 26 and/or the feed spacers 28 may be deposited by a method of direct writing. Direct writing, is a patterning system that allows selective deposition of the surface modifying agents 44 (ceramic or metal-based or polymer) into patterns of coatings at high temperature forming the flow modifiers 42 and/or the flexible structures 46 in one embodiment of the invention described earlier. In another embodiment of the invention, the surface modifying agents 44 may be deposited on the membrane 26 specifically to conform to the geometry of the feed spacer 28, which at times may include constant channel geometry. In one embodiment of the invention, the surface modifying agents 44 may be ceramics-based material. In such cases, materials such as cubic boron nitride, silicon carbide or similar materials may be used either in the form of entrapped coarse grits or in a fine coating.

The direct write technology as may be applied in one embodiment of the invention may be a rapid prototyping method to manufacture the profiled pattern. The pattern is stored as a CAD/CAM file in a computer. The deposition material is formulated to the appropriate consistency for application using a suitable solvent such as terpineol. Cellulose may also be added to impart suitable flow characteristics to the deposition material. The deposition material also is formulated to a consistency similar to that of a fluid slurry or ink, and applied to the membrane 26 and/or the feed spacers 28 at room temperature. Whether the coating material is ceramic, metal-based or polymerizable composite material, there are many ways to direct write or transfer material patterns for rapid prototyping and manufacturing on the deposition surface. In one embodiment of the invention, a dispensing apparatus may be employed for the purpose of direct writing, such as one manufactured by OhmCraft or Sciperio. The pattern applied by the apparatus may be controlled by a computer, connected to the CAD/CAM system that stores and accesses the desired pattern. In one embodiment of the invention, the surface deposition method by direct writing process may be done in an automated manner using a robot, laser, or the like. The pattern thus formed is subsequently cured at elevated temperature for furnace treatment or for local consolidation by laser or electron beams.

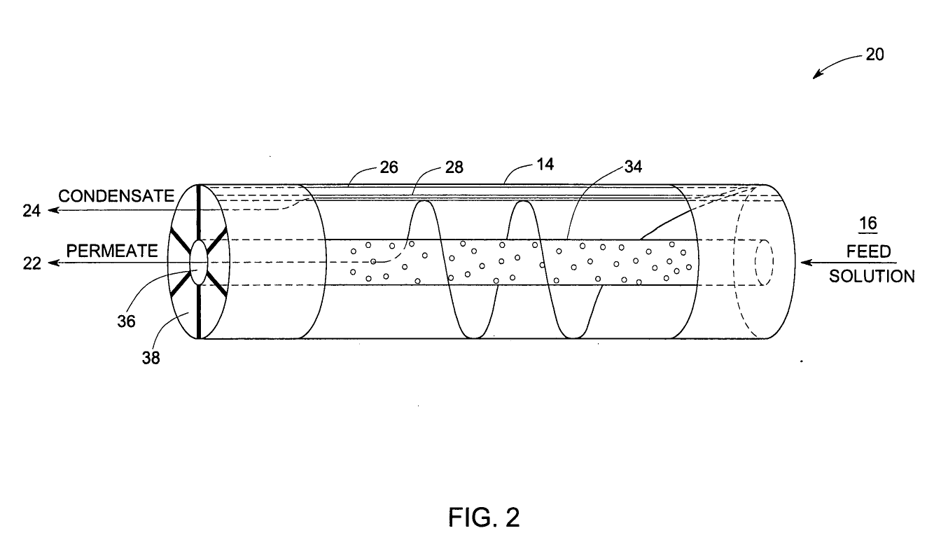

FIG. 2 illustrates an exemplary embodiment of flow of permeate 22 in contaminant removal system 10 of FIG. 1. The feed solution 16 flows axially into inlet 18 of the reverse osmosis membrane system 14. A portion of the feed solution 16 permeates the membrane skin into the adjacent permeate membrane 26. The remaining feed (now condensate) exits through the opposite axial end of the membrane 26. The permeate 22 flows inward to the central porous tube 34 at right angles to the feed solution 16, and spirals down to ultimately leave the spiral winding through the central porous tube 34 and out of the reverse osmosis membrane system 14. To direct the flow path of the feed solution 16 as described, the membranes 26 and the feed spacers 28 are sealed at a number of places. Thus it may be seen that the permeate membranes 26 are sealed on all sides except at the openings 18 and 36 in the central porous tube 34. Seals at the central porous tube 34 between permeate 22 and condensate 24 flows illustrated in FIG. 2 are essential to prevent mixing at that location.

Permeation of a portion of the feed solution 16 through the membrane 26 along the feed-condensate flow path causes a gradual reduction of the feed volume, thereby diminishing feed velocity in a fixed-dimension channel and reducing the downstream permeation efficiency. Design modifications of the reverse osmosis membrane system 14 may reduce such feed velocity changes. In one embodiment of the invention, some design changes may include using tapered spacers 28 to progressively reduce the distance between membranes 26, thereby constricting the downstream flow path and increasing fluid velocity. In another embodiment of the invention, a design change may be to taper the width of the flow path by sealing the edges closer to the middle along the spiral path.

In operation, during the travel of the feed solution 16 through the reverse osmosis membrane 26 of the reverse osmosis membrane system 14 axially from inlet 18 to outlet 36, permeate 22 passes through the minute pores in the sheet-like membrane 26 while the remainder of the feed solution 16 continues to flow in the direction of the outlet 38, growing continuously more concentrated as condensate 24. The permeate 22 travels spirally inward through the membranes 26 and the feed spacers 28 until reaching the porous central tube 34.

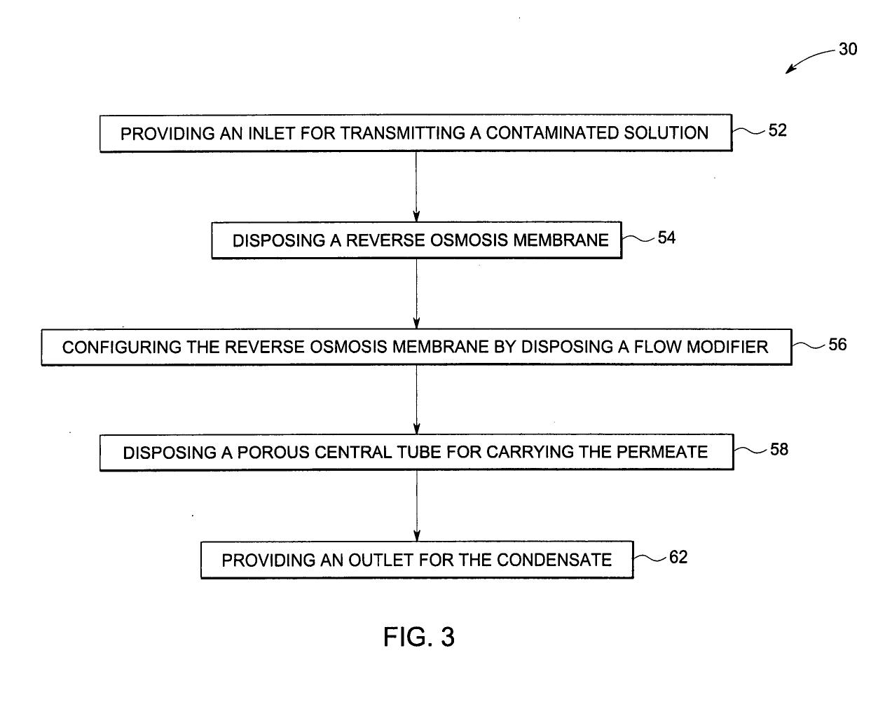

FIG. 3 illustrates an exemplary method 30 for removing contaminants from feed solution in accordance with an embodiment of the invention. The method includes at step 52 providing an inlet for transmitting a contaminated solution, followed by disposing a reverse osmosis membrane in fluid communication with the inlet to receive the contaminated solution at step 54. The reverse osmosis membrane may be modified to achieve high conversion at step 56 by disposing at least one flow modifier on the reverse osmosis membrane to separate condensate and permeate from the contaminated solution. The reverse osmosis membrane may also be modified, by writing the geometry of the feed spacer on the reverse osmosis membrane. The process of modification of the reverse osmosis membrane may also include a number of sub-processes, such as formulating surface modifying agents, writing surface modifying agents on the reverse osmosis membrane and curing the surface modifying agents. In another embodiment of the invention, the method 30 includes, at step 56, modifying the structure of the feed spacer. The process of modification of the feed spacers may also include a number of sub-processes, such as formulating surface modifying agents, writing surface modifying agents on feed spacer structure, and curing surface modifying agents. In another embodiment of the invention both the reverse osmosis membrane surface and the feed spacer structure may be modified. The method 30 further includes disposing a porous central tube at step 58 for carrying the permeate and providing an outlet at step 62 for the condensate.

Embodiments of the invention yield removal of contaminants from a feed solution. It should be appreciated by those skilled in the art that though the description above relates to industrial feed solution purification systems, embodiments of the invention are equally applicable to other low-pressure applications such as ultrafiltration and microfiltration, which are widespread and difficult to implement with high conversion efficiency at low cost.

In one exemplary application, the treatment process may begin with providing water feed which has been exposed to hydrocarbon and/or chemical processing. This may, for instance, include wash water and stripped sour water, as well as feed solution from a steam/methane reformer. The pressure of the water feed may be adjusted to a desired pressure by increasing with the use of a pump or decreasing with a pressure control device or pressure regulator as needed in order for the water feed to pass through the reverse osmosis system.

In one embodiment of the invention, the reverse osmosis process may include either or both of a multi-step process or a multi-stage process, which includes the use of more than one reverse osmosis system, with optional adjustments made between passes of the reverse osmosis systems. An exemplary multi-step process may include the use of more than one reverse osmosis systems, wherein the permeate of an upstream reverse osmosis system is introduced to the inlet of an additional downstream reverse osmosis system. After the multi-step process is complete, the permeate may be recycled into the hydrocarbon or chemical process, especially as wash water and the condensates of each step may be combined and directed to a waste treatment plant.

In another embodiment of the invention, a multi-stage process is meant to include the use of more than one reverse osmosis system wherein the condensate of an upstream reverse osmosis system is introduced to the inlet of an additional downstream reverse osmosis system. This design is to promote a greater recovery of the permeate. After completion of the multi-stage process, the permeates may be combined and recycled as in the multi-step process, and the condensate may be directed to a waste treatment facility. In another embodiment of the invention, two, three or more membrane envelopes of different lengths may be wound about a single central porous tube yielding multiple stages as the feed volume decreases along its spiral path.

In yet another embodiment of the invention, any combination of multi-stage and multi-step processes may be designed depending on which contaminants are to be removed, the desired concentration of contaminants to be removed, and the desired ratio of volume of permeate to condensate. While the efficiency of contaminant removal may vary, the methods of the present invention may achieve a concentration of contaminants in the permeate.

The principle of this invention is useful in any spiral wound membrane device employing flat sheet membrane for reverse osmosis, ultrafiltration, membrane softening, microfiltration, and gas separation, requiring the use of recoveries greater than 20 percent, the limit of currently available reverse osmosis spiral wound elements based on present engineering practice. Embodiments of the invention may allow a single element ranging in lengths of about 12-60 inches to operate under turbulent or chopped laminar flow conditions at recoveries up to 90% while maintaining boundary layer conditions similar to current brine staged spiral system designs using 12 to 18 elements in series. Said another way, the degree of conversion/recovery of the feed stream is less dependent on the length of a module, but rather depends more upon the topography and structure of the flow modifiers, which affects the boundary layer formation of the flow. In another embodiment of the invention, low-pressure applications such as ultrafiltration and microfiltration, the spiral wound element may be optionally mounted permanently in its own pressure container or reverse osmosis membrane system having suitable fittings for connection to the filtration systems.

While the invention has been described in detail in connection with only a limited number of embodiments, it should be readily understood that the invention is not limited to such disclosed embodiments. Rather, the invention may be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed:

1. A contaminant removal system, comprising:
an inlet for transmitting a contaminated solution;
a reverse osmosis membrane having at least one flow modifier, said reverse osmosis membrane configured to separate condensate and permeate from the contaminated solution;
a porous central tube for carrying said permeate; and
an outlet for said condensate.

2. The system of claim 1, further comprising at least one feed spacer.

3. The system of claim 1, wherein said at least one feed spacer further includes at least one flow modifier.

4. The system of claim 1, wherein said at least one flow modifier includes sharp flow obstructions.

5. The system of claim 1, wherein said at least one flow modifier includes embedded silicon.

6. The system of claim 1, wherein said at least one flow modifier includes surface modifying agents.

7. The system of claim 6, wherein said surface modifying agents comprise at least one element selected from the group consisting of polymer-based, ceramics-based, metal-based, and any combination thereof of low viscosity materials.

8. The system of claim 6, wherein said surface modifying agents are deposited on said surface by a direct writing process.

9. The system of claim 1, wherein said reverse osmosis membrane includes flexible flow obstructions.

10. The system of claim 1, wherein said reverse osmosis membrane is concentrically wrapped around said porous central tube.

11. The system of claim 1, wherein said at least one flow modifier is irregularly shaped.

12. A method for removing contaminants from a solution, comprising:
providing a solution having contaminants to a reverse osmosis system, said reverse osmosis system comprising a reverse osmosis membrane having at least one flow modifier;
separating permeate and condensate from the solution; and
transmitting the permeate through a first conduit and the condensate through a second conduit.

13. The method of claim 12, further comprising applying a pressure differential to the reverse osmosis system.

14. The method of claim 12, wherein the first conduit is a porous central tube.

15. The method of claim 12, wherein said at least one flow modifier comprises sharp flow obstructions.

16. The method of claim 12, wherein said at least one flow modifier comprises a flexible portion.

17. The method of claim 12, wherein said at least one flow modifier is irregularly shaped.

18. A method for making a contaminant removal system, comprising:
providing an inlet for transmitting a contaminated solution;
disposing a reverse osmosis membrane in fluid communication with said inlet;
configuring said reverse osmosis membrane by disposing at least one flow modifier on said reverse osmosis membrane;
separating condensate and permeate from the contaminated solution;
disposing a porous central tube for carrying said permeate; and
providing an outlet for said condensate.

19. The method of claim 18, further comprising disposing at least one feed spacer.

20. The method of claim 18, wherein said at least one feed spacer further includes said at least one flow modifier.

21. The method of claim 18, wherein said at least one flow modifier includes sharp flow obstructions.

22. The method of claim 18, wherein said at least one flow modifier includes embedded silicon.

23. The method of claim 18, wherein said at least one flow modifier includes surface modifying agents.

24. The method of claim 23, wherein said surface modifying agents comprise at least one element selected from the group consisting of polymer-based, ceramics-based, metal-based, and any combination thereof of low viscosity materials.

25. The method of claim 23, wherein said surface modifying agents are deposited on said surface by a direct writing process.

26. The method of claim 18, wherein said reverse osmosis membrane includes flexible flow obstructions.

27. The method of claim 18, wherein said reverse osmosis membrane is concentrically wrapped around said porous central tube.
